(19) United States
(12) Patent Application Publication
(10) Pub. No.: US 2022/0300560 A1
(43) Pub. Date: Sep. 22, 2022

(54) VOICE SEARCH REFINEMENT RESOLUTION

(71) Applicant: Amazon Technologies, Inc., Seattle, WA (US)

(72) Inventors: Simone Filice, Tel Aviv (IL); Ajay Soni, Kirkland, WA (US); Omer Shabtai Jakobinsky, Seattle, WA (US); Giuseppe Castellucci, Seattle, WA (US); Anupama Kumari, Bengaluru (IN); Vivek Sarthi, Redmond, WA (US); Oleg Rokhlenko, Kirkland, WA (US)

(21) Appl. No.: 17/249,933

(22) Filed: Mar. 18, 2021

(51) Int. Cl. G06F 16/903; G10L 15/22; G06N 20/00

(52) U.S. Cl. CPC G06F 16/90335; G10L 15/22; G06N 20/00; G10L 2015/223

(57) ABSTRACT

Contextual data corresponding to previous search requests of a service provider's electronic catalog can be used to resolve voice-input search requests and present search results. Contextual data includes the previous search request that is input to a machine learning algorithm along with a present search request. The machine learning algorithm generates a score indicative of whether the present search request is a refinement of the previous search or a new search request. Once the search request is classified as a refinement or a new search, the search is processed to provide search results including available items from the service provider matching the search request.

### CROSS-REFERENCE TO RELATED APPLICATIONS

The specification of U.S. patent application Ser. No. 17/205,872, filed Mar. 18, 2021, entitled “VOICE SEARCH ATTRIBUTE IDENTIFICATION AND REFINEMENT,” is hereby incorporated by reference herein in its entirety.

### BACKGROUND

Voice interfaces of electronic devices, such as voice-controlled devices, can be used to receive and process instructions from users. For example, a user can instruct a voice-controlled device to perform a query in a database of items. So long as the user correctly and clearly identifies the query information, a backend server associated with the voice-controlled device will likely be able to process the query and produce a listing of matching results.

When the user's instructions with respect to a query are vague or otherwise less definite such as follow-up queries on an initial search, correctly identifying the user goal may prove challenging.

### BRIEF DESCRIPTION OF THE DRAWINGS

Various embodiments in accordance with the present disclosure will be described with reference to the drawings, in which:

FIG. 1 is an example block diagram and associated flowchart showing a process for implementing techniques relating to search refinement using voice inputs and implicit information, according to at least one example.

FIG. 2 is an example schematic architecture for implementing techniques relating to search refinement using voice inputs and implicit information, according to at least one example.

FIG. 3 illustrates an example device including a refinement score engine and a plurality of components, according to at least one example.

FIG. 4 illustrates an example chart illustrating an example structure for the refinement score engine, according to at least one example.

FIG. 5 is a flow diagram of a process depicting example acts for implementing techniques relating to search refinement using voice inputs and implicit information, according to at least one example.

FIG. 6 is a flow diagram of a process depicting example acts for implementing techniques relating to performing searches of item databases using search refinement information, according to at least one example.

FIG. 7 illustrates an environment in which various embodiments can be implemented.

### DETAILED DESCRIPTION

Examples described herein are directed to, among other things, techniques for processing voice search requests and determining whether a particular voice search request is a refinement of an earlier search request or a new search request independent of earlier search requests. The determination by a computing device of whether a particular second voice search request is a refinement of a first search request or a new search request may be based on contextual information such as, for example, when the second voice search request is ambiguous or lacking explicit information instructing the computing device whether to filter or start a new search of the item database, e.g., when a user first searches for running shoes and follows up with a request to “show me red shoes,” which could be either a request to filter the running shoes by the color red or could also be a request for a new search entirely. Although described herein with reference to a first search and a second search, it will be understood that the systems and methods described herein are applicable to subsequent search requests, e.g., third, fourth, fifth, and so on, and the description is intended to cover such iterative search turns.

Conventional approaches for processing voice search requests typically require a user to provide an explicit statement that the voice request is a refinement of the first search or, in other examples to explicitly provide all information from the first search request again in the second voice request, such as a user providing an item type in the first request and subsequently, in the second voice request, including the item type and a desired refinement, such as a color, variation, configuration, or other subset of the item type. In some cases, these approaches may fail at returning the results expected by the user or performing the search in the manner expected by the user in response to the second voice request since the second voice request may lack the implicit context or the explicit information of the first search request, or the user's intent may be ambiguous with respect to whether the second voice request is a refinement of the first search request or an entirely new search. Failing to take into account the possibility of the second voice request being a refinement of the first search request can be frustrating to some users as it forces them to perform additional steps to provide all explicit information in a single request, which may be unnatural and difficult to reproduce in the context of interacting with a voice assistants or other voice interfaces. This makes some voice requests unnatural and in some instances affects the overall user experience with using voice assistants and other voice-controlled systems and devices.

Techniques described herein are directed to approaches for processing voice requests from a user for searches and determining whether the voice request is for a new search or whether the voice request is for refining a previously entered search request. The voice request may be received through a user interface, such as a microphone of a user device including a voice assistant. A search request is identified from the voice request using a natural language processing algorithm. The search request and the contextual information are used in conjunction to fulfill requests and provide a listing of search results or some other action that may be unidentifiable based solely on the information of the voice search request out of context. A refinement scorer of the user device may overcome some of the issues faced in the aforementioned conventional approaches. The refinement scorer takes into account different types of contexts as well as search request history, as well as relational and time-based contexts. The refinement scorer may be implemented in a machine learning algorithm that receives the inputs of explicit, implicit, and contextual information and outputs a probability score indicative of whether the new request is a refinement of a previous search or not. The machine learning algorithm may be trained using voice command data including both implicit and explicit commands to a voice-controlled device.

Turning now to a particular example, a user may initially perform a search of an item catalog of an electronic marketplace by inputting a search request into a search engine configured to search the item catalog. The initial search request may explicitly identify an item type and one or more item attributes, for example “red shoes.” Subsequently, after receiving the search results for the “red shoes” search, the user may decide they wish to refine their search to “running shoes” or some other subset of the red shoes listed in the search results. With a voice-controlled device, the user may utter a request to “show me running shoes” or by simply saying “running shoes” or even just “running.” In a typical system, the voice request for running shoes would be initiated as a new search, not a continuation of the red shoes, even though the user intends to view “red running shoes.” Additionally, the voice-controlled device may be unable to parse what the user intends through the utterance “running” as no item type is identified to enter into the catalog search.

The refinement scorer receives the initial input search for “red shoes” as well as the second inputs, as voice inputs, listed above. The refinement scorer outputs a probability score indicating that the user intends a refinement of the initial search for red shoes based on contextual information, such as screen context, time between the initial input and the second input, relations between an item identified in the initial input and the second input, and other such contextual and relational information and filters the search results shown after the first request to only include items that match the search terms “red running shoes.” The refinement scorer is able to provide for refining search results when the request is not clear or is ambiguous as to whether the user wishes to start a new search or filter previous search results. For example, a user may explicitly state that they wish to “filter by red” such that the voice-controlled device is able to process the request due to the explicit request to “filter.” In another example, a user may search for a “television” and then follow up with a request to “search for X brand.” Rather than performing a new search of items corresponding to X brand, the refinement scorer identifies the request as a refinement and filters the search results for “television” by results corresponding to “X brand.” In these example voice commands, the explicit information included in the voice request may be insufficient for the voice-controlled device to complete a request, such as a request to “search for four stars” by which a user intends to “only show me four star results.” In conventional methods, the user would then have to follow up with additional information, for example by specifying that they wish to filter or by performing a new search and appending all desired filters into a single search request.

In some examples, other contextual data can be used to identify and clarify ambiguous voice requests or further define a search request as a refinement over a new search. For example, the context may include browsing history, a time difference between the first and second requests, screen context of the user device, relational information, or other such contextual information.

The techniques and methods described herein provide several advantages over conventional voice-control systems and methods. For example, the techniques described herein provide simpler and faster use of voice-controlled devices for quickly refining search requests of a catalog of an electronic marketplace by reducing the number of steps (e.g., filter selections, click throughs, page views, toggle buttons, etc.) and/or requiring specific non-conversational language from the user to accomplish a particular command. The techniques described herein also enable processing of voice commands that would otherwise not be possible for a voice-controlled device to process by providing a voice-controlled device with the ability to process voice commands with implicit information rather than solely on explicit information provided in a voice request.

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

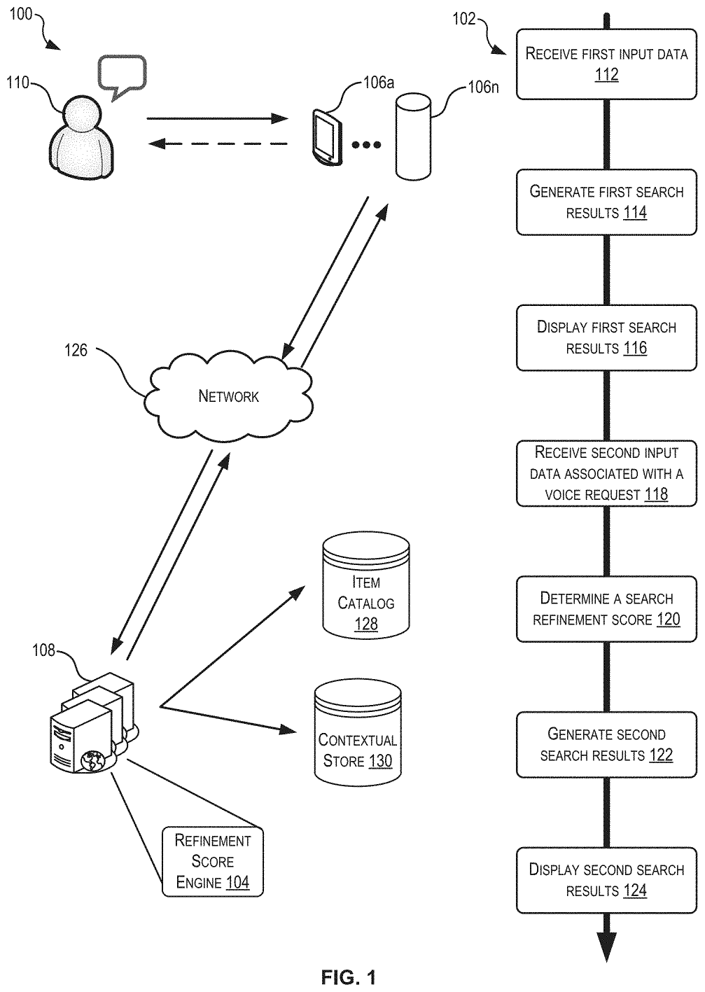

Turning now to the figures, FIG. 1 is an example diagram 100 and associated flowchart showing a process 102 for implementing techniques relating to search refinement using voice inputs and implicit information to voice-controlled devices, according to at least one example. The diagram 100 depicts devices, objects, and the like that correspond to the process 102. The process 102 can be performed by a user device, a server computer, or some combination of the two. In some examples, a refinement score engine 104, which may be implemented in a server computer (e.g., service provider 108) to determine perform the techniques described herein, e.g., determine whether a voice request is a refinement or continuation of a previous voice request. In some examples, at least a portion of the refinement score engine 104 is implemented by a user device 106 (e.g., a mobile device or a voice-controlled device). In some examples, the techniques described herein may be multi-modal, and be performed using interactions from one or more user devices 106. For example, a first search request may be input at a first user device while a second search request is provided through a voice controlled user device separate from the first user device. In this manner, the searches by a user may be continued across user devices. This may be accomplished by using the user account information and user history to continue a search request after the user moves to a different device.

The process 102 may begin at 112 by the user device 106 receiving first input data. The first input data may be typed, voice input, or otherwise provided to user device 106. The first input data may include information for searching or otherwise interacting with a service, such as a datastore or a web application, such as a catalog of an electronic marketplace. The first input data may, for example, include a first search request to search the catalog for items of a particular type. The first input data is provided by user 110. For example, the first input data may include the user 110 speaking at the user device 106 via a voice interface of the user device 106. The user device 106 processes the voice command and carries out one or more actions in response to the first input data. The user device 106, in response to the first input data, may send a request to the service provider 108 to search a database such as a catalog of an electronic marketplace based on the first input data. The user device 106 may include a variety of example user devices, including computing devices, smartphones, standalone digital assistant devices, wearable device such as a watch or eyewear, tablet devices, laptop computers, desktop computers, and other such user devices.

At 114, the process 102 may include the service provider 108 generating first search results based on the first input data. After the first input data is received at 112 and processed, the service provider 108 may also cause one or more actions to be performed, such as producing search results for display at the user device 106 based on search terms included within the first input data, and may perform such actions by communicating with one or more systems, such as an item catalog 128 over a network 126.

At 116, the process 102 may include displaying, at the user device 106, the first search results. The first search results may be displayed, for example, on a display of the user device 106. The display of the user device 106 may also include one or more interactive filters for filtering the first search results. The item catalog 128 may include listings, descriptions, and information related to various items and products available from the electronic marketplace hosted by the service provider 108.

At 118, the process 102 may include receiving second input data associated with a voice request. The second input data may be received at the user device 106 via a microphone or other voice interface of a device communicably coupled with the user device 106. The second input data may be processed using a natural language processing algorithm to generate one or more search terms, however, the search terms and/or the language of the second input data may not be explicit with respect to whether the user 110 intends to refine or further filter the first search results displayed at 116 or start a new search.

The second input data may include additional data, for example including contextual data from a contextual store 130. The contextual store 130 may store information related to an environment, a time, a location, data files in use or previously used by the user device 106, or any other related or relevant information that may be useful in providing insight or implicit information to aid in the processing of a voice command that is ambiguous with respect to a particular action or data object. For example, the contextual store 130 may include information relating to a string of searches and refinements, search history, and present information displayed on a screen of the user device 106.

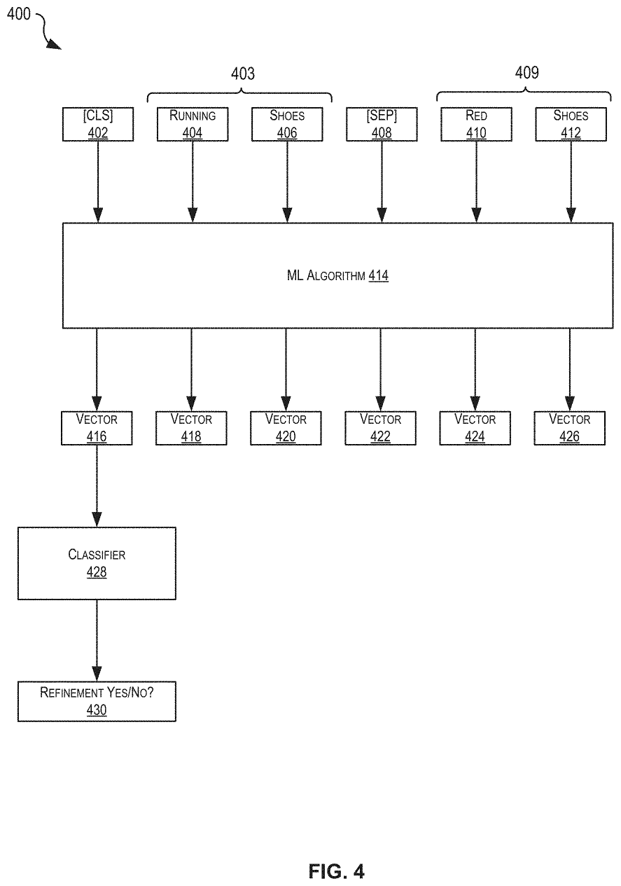

At 120, the process 102 may include determining a search refinement score using a machine learning algorithm, such as a machine learning algorithm of the refinement score engine 104. The machine learning algorithm may be trained with search terms and requests as well as refinement searches and filtering searches following up on initial searches, especially those searches that do not explicitly state whether the user 110 intends to start a new search or refine a previous search. The machine learning algorithm may be a transcoder based algorithm trained on natural language inputs. In some examples, the score may be generated by one or more algorithms, such as by initially processing voice requests with a first algorithm and second performing a refinement score probability determination using a second machine learning algorithm. In some examples the machine learning algorithm that outputs the refinement score may be a Bidirectional Encoder Representations from Transformers (BERT), or other such algorithm. The machine learning algorithm is described in further detail with respect to FIG. 4.

In some examples, the machine learning algorithm may also receive contextual inputs that describe one or more contexts at a particular time when the second input data is received. The contextual data may include data relating to data objects previously and/or currently in use by the user device 106, including current screen context information, historical search results, location information, such as a location of the user device 106. The contextual data may also include data relating to the time of the first and second input data. For instance, the time data may include a time of day, a day of the week, a month, a holiday, a particular season, or other such temporal information that may provide context clues for the environment the user 110 is situated in. The contextual data may include one or all of a number of contextual parameters describing an environment, condition, status, or location the user device 106 as well as potential relations between subsequent search requests via the user device 106.

At 122, the process 102 may include generating second search results. The second search results include listings of items from the item catalog 128 that fit or match the second set of search terms. In the event the refinement score exceeds a threshold value, indicating a high probability that the user 110 intended a refinement, the second search terms and the second search results may be a refinement of the first search terms and first search results, for example by filtering with additional descriptors or limits on the search. In some examples, the second set of search terms may be a new search request that includes all of the first search terms as well as the second search terms. In the event the refinement score does not reach or exceed the score threshold, the second search terms may be searched in the item catalog 128 as a new search independent of the first search terms.

At 124, the process 102 may include displaying the second search results. The second search results may be displayed at the user device 106 or any other suitable display for the user 110 to view the results of the second search.

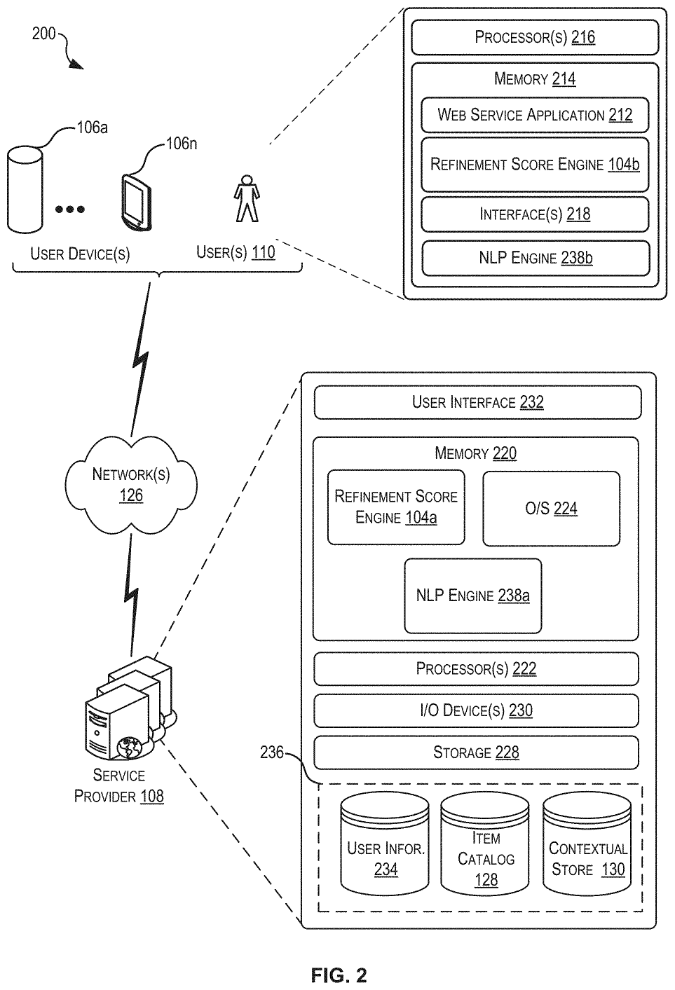

FIG. 2 is an example schematic architecture for implementing techniques relating to search refinement using voice inputs and implicit information, according to at least one example. The architecture 200 may include the service provider 108 in communication with one or more user devices 106a-106n via one or more networks 126 (hereinafter, “the network 126”).

The user device 106, which may include a mobile device such as a smartphone, a computing device, a voice-controlled device, or other such device, may be operable by one or more users 110 to interact with the service provider 108. The user device 106 may be any suitable type of computing device such as, but not limited to, a wearable device, voice-controlled device (e.g., a smart speaker), a tablet, a mobile phone, a smart phone, a network-enabled streaming device (a high-definition multimedia interface (“HDMI”) microconsole pluggable device), a personal digital assistant (“PDA”), a laptop computer, a desktop computer, a thin-client device, a tablet computer, a high-definition television, a web-enabled high-definition television, a set-top box, etc. For example, the user device 106a is illustrated as an example of voice-controlled user device, while the user device 106n is illustrated as an example of a handheld mobile device. In some example, the user device 106a may be connected to a voice-controlled intelligent personal assistant services. The user device 106a may respond to some predefined “wake word” such as “computer.” In some examples, the user device 106a is capable of voice interaction, music playback, making to-do lists, setting alarms, streaming podcasts, playing audiobooks, and providing weather, traffic and other real-time information. In some examples, the user device 106a can also control several smart devices acting as a home automation hub. In some examples, electronic content items are streamed from the service provider 108 via the network 120 to the user device 106. The user device 106n may include a voice interface to interacting with and using a voice-assistant similar to user device 106a, described above.

The user device 106 may include a memory 214 and processor(s) 216. In the memory 214 may be stored program instructions that are loadable and executable on the processor(s) 216, as well as data generated during the execution of these programs. Depending on the configuration and type of user device 106, the memory 214 may be volatile (such as random access memory (“RAM”)) and/or non-volatile (such as read-only memory (ROM), flash memory, etc.).

In some examples, the memory 214 may include a web service application 212, a refinement score engine 104b, and a natural language processing engine 238. In some examples, the natural language processing engine 238 may be a component of the refinement score engine 104b. The web service application 212 and/or the refinement score engine 104b may allow the user 110 to interact with the service provider 108 via the network 120. Such interactions may include, for example, searching the item catalog, providing filters to filter search results from the item catalog, creating, updating, and managing user preferences associated with the user 110 and/or any one of the user devices 106. The memory 214 also includes one or more user interfaces 218. The interfaces 218 may enable user interaction with the user device 106. For example, the interfaces 218 can include a voice interface to receive voice instructions and output verbal information, prompts for information, and other requested information. The interfaces 218 can also include other systems required for input devices such as keyboard inputs or other such input mechanisms for inputting information into the user device 106.

Turning now to the details of the service provider 108, the service provider 108 may include one or more service provider computers, perhaps arranged in a cluster of servers or as a server farm, and may host web service applications. The function of the service provider 108 may be implemented a cloud-based environment such that individual components of the service provider 108 are virtual resources in a distributed environment. The service provider 108 also may be implemented as part of an electronic marketplace (not shown).

The service provider 108 may include at least one memory 220 and one or more processing units (or processor(s)) 222. The processor 222 may be implemented as appropriate in hardware, computer-executable instructions, software, firmware, or combinations thereof. Computer-executable instruction, software, or firmware implementations of the processor 222 may include computer-executable or machine-executable instructions written in any suitable programming language to perform the various functions described. The memory 220 may include more than one memory and may be distributed throughout the service provider 108. The memory 220 may store program instructions that are loadable and executable on the processor(s) 222, as well as data generated during the execution of these programs. Depending on the configuration and type of memory including the service provider 108, the memory 220 may be volatile (such as RAM and/or non-volatile (such as read-only memory (“ROM”), flash memory, or other memory). The memory 220 may include an operating system 224 and one or more application programs, modules, or services for implementing the features disclosed herein including at least the refinement score 104a and a natural language processing engine 238.

The service provider 108 may also include additional storage 228, which may be removable storage and/or non-removable storage including, but not limited to, magnetic storage, optical disks, and/or tape storage. The disk drives and their associated computer-readable media may provide non-volatile storage of computer-readable instructions, data structures, program modules, and other data for the computing devices. The additional storage 228, both removable and non-removable, is examples of computer-readable storage media. For example, computer-readable storage media may include volatile or non-volatile, removable, or non-removable media implemented in any suitable method or technology for storage of information such as computer-readable instructions, data structures, program modules, or other data. As used herein, modules, engines, applications, and components, may refer to programming modules executed by computing systems (e.g., processors) that are part of the service provider 108 and/or part of the user device 106.

The service provider 108 may also include input/output (I/O) device(s) and/or ports 230, such as for enabling connection with a keyboard, a mouse, a pen, a voice input device, a touch input device, a display, speakers, a printer, or other I/O device.

In some examples, the service provider 108 may also include one or more user interface(s) 232. The user interface 232 may be utilized by an operator, curator, or other authorized user to access portions of the service provider 108. In some examples, the user interface 232 may include a graphical user interface, voice interfaces, web-based applications, programmatic interfaces such as APIs, or other user interface configurations. The service provider 108 may also include the data storage 236. In some examples, the data storage 236 may include one or more databases, data structures, or the like for storing and/or retaining information associated with the service provider 108. Thus, the data storage 236 may include data structures, such as a user information database 234, the item catalog 128, and a contextual store 130.

The user information database 234 may be used to retain information pertaining to users of the service provider 108 such as the user 110. Such information may include, for example, user preferences, user account information (e.g., electronic profiles for individual users), demographic information for users, payment instrument information for users (e.g., credit card, debit cards, bank account information, and other similar payment processing instruments), account preferences for users, purchase history of users, wish-lists of users, search histories for users, and other similar information pertaining to a particular user, and sets of users, of the service provider 108.

In some examples, the user preferences stored in the user information database 234 may be specific to particular user devices, to particular users, or to any combination of the foregoing. For example, the user 110 may be associated with a plurality of user devices of the user devices 106a-106n. In this example, the user 110 may be a primary user and may create specific user preferences for each of the plurality of user devices 106 such that each of the plurality of user devices 106 are operable in accordance with its respective user preferences, which may be identified based at least in part on a user profile of the user 110. In this manner, the user preference may be fixed to the user device 106, irrespective of which user is accessing the user device 106. In some examples, the user 110 may set up primary user preferences, which may be the default user preference when a new user device is associated with the user. This configuration for managing user preferences may be desirable when the primary user is a parent and at least some of the user devices 106 that are associated with the primary user are used by children of the primary user.

In some examples, each of the users 110 may have their own user preferences (e.g., as part of a user profile) that may be portable between any of the user devices 106. Such user preferences may be associated with a particular user device 106 after the user 110 logs in to the user device 106 (e.g., logs into the refinement score engine 104) using user credentials. This configuration for managing user preferences may be desirable when each of the users 110 is capable of managing its own user preferences.

The item catalog 128 may include an expansive collection of listings of items available from an online retailer available for access, such as to purchase, rent, or otherwise interact with. The item catalog 128 may be searchable by the user device 106 using any suitable technique including those described herein. In some examples, the organization of data from the item catalog 128 may be represented by one or more search indices. In some examples, the item catalog 128 includes a plurality of searchable fields for each content item stored in the item catalog 128. Such fields may be specific to the type of item, with at least some fields being generic across types. For example, for an item type such as article of clothing, such data fields may include size, color, material, configuration, intended use, and other such information. In some examples, the values in the metadata fields may be represented by numerical codes. For example, the color may be represented by a number associated with a particular shade of a color.

The contextual store 130 may include information about historical actions and/or historical search parameters as well as information related to an environment, a time, a location, data files in use or previously used by the user device 106, or any other related or relevant information that may be useful in providing insight or implicit information to aid in the processing of a voice command that is ambiguous with respect to a particular action or data object. For example, the contextual store 130 may include information relating to a string of searches and refinements, search history, and present information displayed on a screed of the user device 106. After a search has been generated for a current voice command or other input, the search and associated voice command can be saved in the contextual store 130 in association with the user account. The refinement score engine 104 may access the contextual store 130 for additional implicit information, and/or to identify previous searches that a subsequent user input may be in reference to, for example to further refine.

During use, the user 110 provides a first input to the user device 106. The user device 106 may process the first input or may convey the voice command to the service provider 108 for processing using a natural language processing algorithm, such as embodied in the NLP engine 238a. In some examples, the user device 106 may include the natural language processing engine 238b. The natural language processing algorithm may be implemented through the web service application 212 or may, in some examples be part of the refinement score engine 104. The first input may be processed to return items corresponding to a search request, as extracted from the first input, and a representation of the items may be shown on a display of the user device 106. During continued use, the user 110 provides a second input to the user device 106, the second input is a voice input and may be ambiguous as to whether the user 110 is performing a new search or is refining the first search. The second input is processed by the NLP engine 238 in a manner similar to the first input. The refinement score engine 104 receives the output of the NLP engine 238 as well as contextual data to process the second input. The contextual data may include information related to an environment, a time, a location, data files in use or previously used by the user device 106, or any other related or relevant information that may be useful in providing insight or implicit information to aid in the processing of a voice command that is ambiguous with respect to a particular action or data object. The refinement score engine 104 determines, based on the inputs, whether the ambiguous input of the second input is a refinement of the first input or is a new search and causes the corresponding action to be taken, e.g., refining the search based on the voice input or beginning a new search based on the voice input. Operations described with respect to the user device 106 may be carried out on the device or on a computing system of the service provider 108, for example in a cloud computing arrangement.

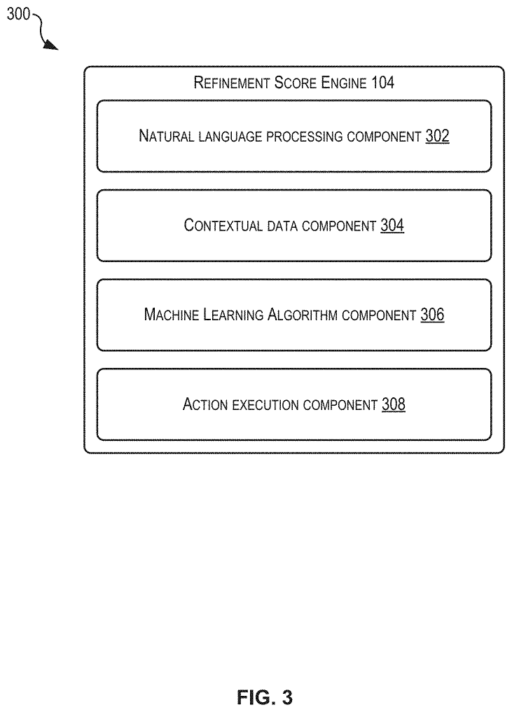

FIG. 3 illustrates an example device 300 including the refinement score engine 104 and a plurality of components 302-308, according to at least one example. The refinement score engine 104 may be configured to manage one or more sub-modules, components, engines, and/or services directed to examples disclosed herein. For example, the refinement score engine 104 includes a natural language processing component 302, a contextual data component 304, a machine learning algorithm component 306, and an action execution component 308. In some examples, the natural language processing component 302 may be separate from the refinement score engine 104, as illustrated in FIG. 2. While these modules are illustrated in FIG. 3 and will be described as performing discrete tasks with reference to the flow charts, it is understood that FIG. 3 illustrates example configurations and other configurations performing other tasks and/or similar tasks as those described herein may be implemented according to the techniques described herein. Other modules, components, engines, and/or services may perform the same tasks as the refinement score engine 104 or other tasks. Each module, component, or engine may be implemented in software, firmware, hardware, and in any other suitable manner.

Generally, the natural language processing component 302 is configured to provide a voice interface to enable communication between a user such as the user 110 and a device such as the user device 106. For example, this can include enabling conversations between the user 110 and the user device 106, receiving instructions from the user 110, providing search results to the user 110, and any other suitable communication approach. The natural language processing component 302 may process the voice command from the user 110 to identify a user request within the voice command. The natural language processing component 302 implements known natural language processing algorithms to receive spoken instructions from the user 110 and output user requests for action by the user device 106.

Generally, the contextual data component 304 is configured to receive, store, and determine contextual data variables describing environmental parameters and conditions in association with a voice command from the user 110. The contextual data may identify a currently or previously searched request of the item catalog, a time of the voice command from the user, or other such data describing the environment and contextual information occurring at the time of the voice command from the user 110.

Generally, the machine learning algorithm component 306 receives inputs from the natural language processing component 302 describing the user request and natural language inputs from voice data from the user as well as inputs of contextual data from the contextual data component 304 describing the conditions and context surrounding the voice request. The machine learning algorithm component 306 may include a Bidirectional Encoder Representations from Transformers (BERT), or other such algorithm capable of processing natural language strings, such as search terms, and identifying a predicted intended output in the case of an ambiguous input from the user 110. The machine learning algorithm component 306 may be trained using data of user voice requests and identifications of search refinements versus new searches when the voice request is ambiguous. The machine learning algorithm component 306 outputs a score indicative of a probability that the voice request is a refinement of a previous search request or a probability that a voice request is a request for a new search instead of a refinement, especially in cases where the voice request is ambiguous as to whether the user 110 intends to refine the search or start anew. The probability score may be presented as a numerical score, such as between zero and one or between one and one hundred with a higher score indicative of a higher probability of a search continuation. The score may include one or more scores, for example with a first score output indicative of a probability that the user intended to refine the search results. The first score output may be provided as an input to the machine learning algorithm, or to a second machine learning algorithm, that further refines the probability score by iterating the analysis of the inputs.

Generally, the action execution component 308 is configured to execute an action with a search request after identified as a refinement or a new search by the machine learning algorithm component 306. For example, the action execution component 308 may cause the search results displayed on the user device 106 to be filtered or refined in accordance with the voice request, or may initiate a new search request.

FIG. 4 illustrates an example chart illustrating an example structure 400 for the refinement score engine, according to at least one example. In the example structure 400, the Machine Learning (ML) algorithm 414 is a machine learning model, such as the machine learning algorithm component 306 of FIG. 3 as described herein and known in the art capable of processing natural language inputs. The classifier may be a further machine learning algorithm, such as an additional component of the refinement score engine 104, as part of the machine learning algorithm component 306, or other such structures. Though ML algorithm 414 is described as BERT herein, other machine learning models and algorithms are envisioned that are able to receive sentence pairs as inputs and perform natural language processing tasks. In the example shown, elements 402-412 include inputs into ML algorithm 414, while the ultimate output at 430 is a determination of whether the second sentence of the pairs input is a refinement of the first or not.

The inputs, elements 402-412 include a classifier token (CLS) 402, the first search terms 403 including search terms “running” 404 and “shoes” 406, a separator (SEP) 408, and the second search terms 409 including search terms “red” 410 and “shoes” 412. The first search terms 404 and 406, in the example shown, are “running shoes.” The first search terms 404 and 406 may be input using a keyboard, voice input, or any other suitable input device into the user device 106. The second search terms 410 and 412 are shown, in this example, as “red shoes.” In this particular example, the voice input of “red shoes” is not accompanied by an explicit request to filter or refine the “running shoes” search but is ambiguous in that respect. It is unclear, at the time of the second input of “red shoes” whether the user 110 wants to start a new search for red shoes or whether the user 110 wants to refine the running shoes search to show “red running shoes.”

The outputs of ML algorithm 414 include a number of vectors 416-426, with a vector associated with each input, elements 402-412. Each of the vectors may influence one another, for example with the information contained in each vector having an impact on a related vector, such as whether a first vector includes an attribute of an item or whether the first vector is a reference to a category of items and therefore influences the second vector, which may be identified as including a filterable string, such as a refinement of the search. The first vector 416 is passed on to classifier 428 which performs a classification task as a logistic regression model. The output of the classifier 428 is a score indicative of a probability that the second search terms, second search terms 410 and 412, are a refinement of the first search or not.

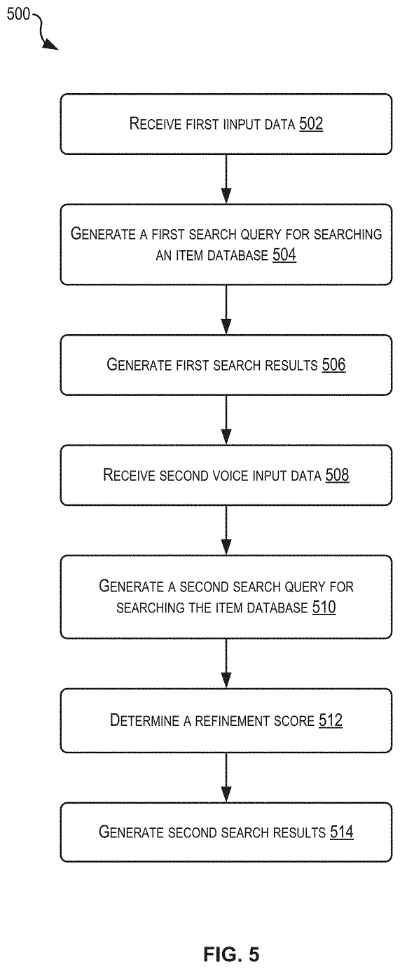

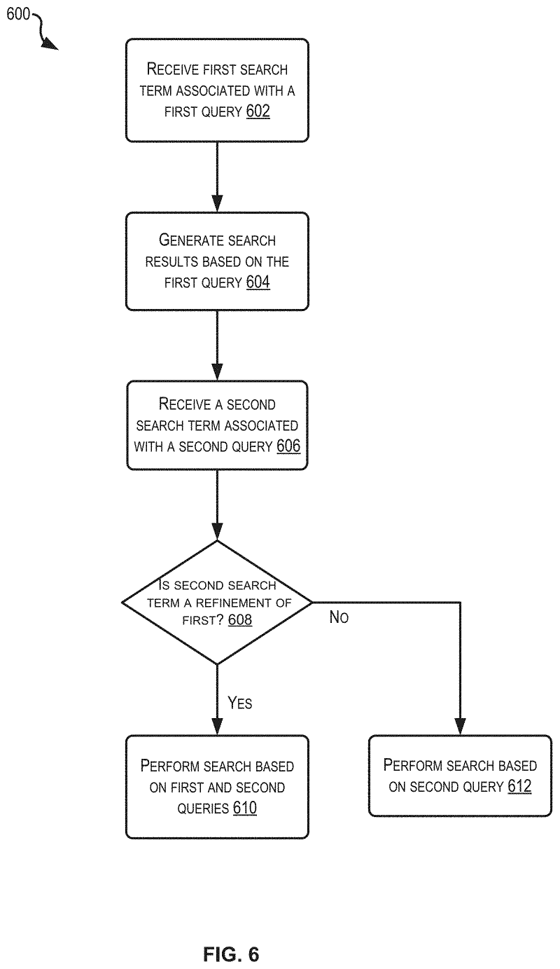

FIGS. 5 and 6 illustrates example flow diagrams showing processes 500 and 600 as described herein. The processes 500 and 600 are illustrated as a logical flow diagram, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be omitted or combined in any order and/or in parallel to implement the processes.

Additionally, some, any, or all of the processes 500 and 600 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable storage medium, for example, in the form of a computer program comprising a plurality of instructions executable by one or more processors. The computer-readable storage medium is non-transitory.

FIG. 5 is a flow diagram of a process 500 depicting example acts for implementing techniques relating to search refinement using voice inputs and implicit information, according to at least one example. The refinement score engine 104 embodied in the service provider 108 (FIG. 1) and/or in the user device 106 (FIG. 2) may perform the process 500. In some examples, the refinement score engine 104 may be distributed among the service provider 108 and the user device 106 and may perform the process 500 of FIG. 5.

The process 500 may begin at 502 with the service provider 108 receiving first input data from a user 110. The first input data may include a voice request or a typed input, such as an input into a search box of a web site for searching an item catalog 128 of an electronic marketplace hosed by the service provider. The first input data may be received as a string that may be processed with a natural language processing algorithm.

At 504, the process 500 includes the service provider 108 generating a first search query for searching an item catalog 128 of the electronic marketplace. The first search query may include the first input data typed in by the user and/or the output of the natural language processing algorithm. The first search query may be formatted in any appropriate format for searching the item catalog 128.

At 506, the process 500 includes the service provider 108 generating first search results. The first search results are generated in response to submitting the first search query to the service provider 108. The first search results include a listing or representation of items available from the service provider 108 that match, closely match, or are related to one or more of the search terms of the first search query.

At 508, the process 500 includes the service provider 108 receiving second voice input data. The second voice input data may be ambiguous as to whether the user wishes to start a new search or refine a previous search, such as “show me red shoes” following a search for “running shoes.”

At 510, the process 500 includes the service provider 108 generating a second search query for searching the item database. The second search query may include an output of the natural language processing algorithm after the second voice input data is received. The second search query may be formatted in any appropriate format for searching the item catalog 128.

At 512, the process 500 includes the service provider 108 determining a refinement score for the second search query. Determining the refinement score may include providing the first search query and the second search query to a machine learning algorithm, trained using search refinement request data from natural language voice requests. The machine learning algorithm may also receive contextual inputs as described herein, such as a difference in time between the first input data and the second input data. A large difference in time between the first and second input data may correspond to a lower likelihood that the second search request is for refining the first.

At 514, the process 500 includes the service provider 108 generating second search results. The second search results may include performing a new search when the refinement score is below a predetermined threshold or performing a refinement or filtering of the first search results using the second search query to produce the second search results. The search results may represent items available from the service provider, as described with respect to the first search results.

Although the steps and elements of process 500 have been described with respect to the service provider 108 performing some or all of the steps, some or all of the steps may be performed at a user device 106, for example, by having the user device 106 process the voice inputs or other such actions.

Though described herein with respect to a first and a second search request, the process 500 may be performed on multiple subsequent search requests, for example as a user continues to refine their initial search, they may provide third, fourth, fifth search requests, and so on, without explicitly indicating that they intend to refine their search. In such examples, the process 500 may be continued and repeated with subsequent requests, from at least 508 through 514 to continue to determine the implicit intent of the user. In such examples, the inputs to ML algorithm 414 may include all subsequent search strings or terms, and not just two as illustrated.

FIG. 6 is a flow diagram of a process depicting example acts for implementing techniques relating to performing searches of item databases using search refinement information, according to at least one example. The refinement score engine 104 embodied in the service provider 108 (FIG. 1) and/or in the user device 106 (FIG. 2) may perform the process 600. In some examples, the refinement score engine 104 may be distributed among the service provider 108 and the user device 106 and may perform the process 600.

At 602, the process 600 includes the service provider 108 receiving a first search term associated with a first query. The first search term may include a string or multiple terms. The first search term may be input through a voice input device of a user device 106, typed in through a user interface of a user device 106, or otherwise input with an input device and communicated to service provider 108 over network 126.

At 604, the process 600 includes the service provider 108 generating search results based on the first query. The search results may include items from an item catalog that match or closely match at least part of the first search term. The search results may be displayed at the user device 106.

At 606, the process 600 includes the service provider 108 receiving a second search term associated with a second query. The second search term may include a string or multiple terms. The second search term is received as a voice request. In particular, the second search term may be input through an interaction by a user 110 with a voice assistant or through a voice-controlled device, such as a voice-controlled user device. The second search term may not identify whether the user 110 intends to initiate a new search or refine the first search results.

At 608, the process 600 includes the service provider 108 determining whether the second search term is a refinement of the first search term. The service provider 108 may determine whether the second search term is a refinement through the use of the refinement score engine 104 described above. The service provider 108 may determine whether the second search term is a refinement by generating a refinement score. Determining the refinement score may include providing the first search term and the second search term to a machine learning algorithm, trained using search refinement request data from natural language voice requests. The machine learning algorithm may also receive contextual inputs as described herein, such as a difference in time between the first input data and the second input data. A large difference in time between the first and second input data may correspond to a lower likelihood that the second search request is for refining the first.

At 610, the process 600 includes the service provider 108 performing a search based on the first and the second queries in response to the service provider 108 determining that the second search term is a refinement of the first search term. The search performed at 610 may be a refinement, such as filtering the first search results based on the second search term or may initiate a new search using both the first and second search terms. The results of the search may be output or conveyed to a user device 106.

At 612, the process 600 includes the service provider 108 performing a search based on the second query in response to the service provider determining that the second search term is not a refinement of the first search term. The search performed at 612 may be performed by the service provider searching the item catalog based on the second query and thereafter providing the search results to a user device 106.

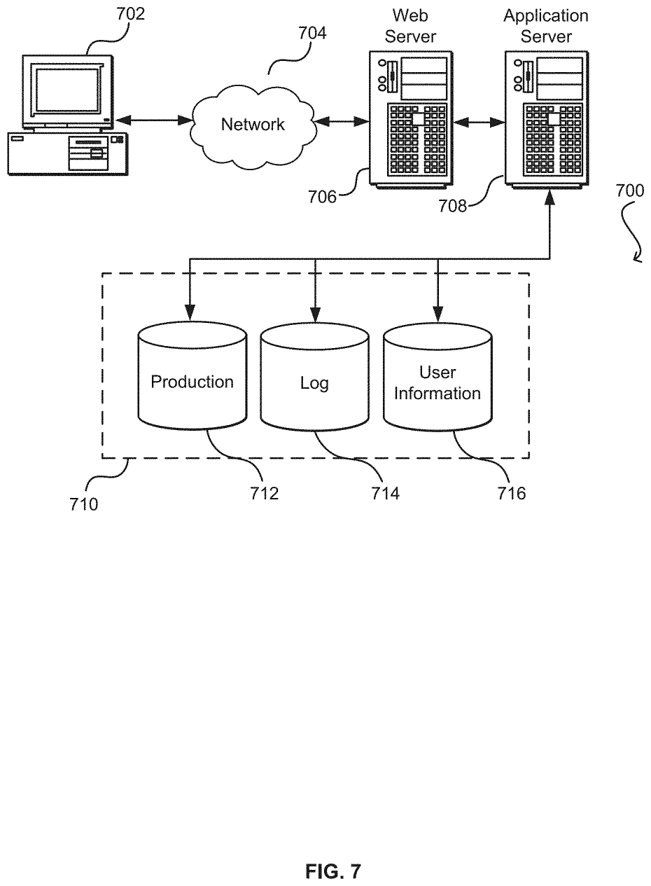

FIG. 7 illustrates aspects of an example environment 700 for implementing aspects in accordance with various embodiments. As will be appreciated, although a Web-based environment is used for purposes of explanation, different environments may be used, as appropriate, to implement various embodiments. The environment includes an electronic client device 702, which can include any appropriate device operable to send and receive requests, messages, or information over an appropriate network 704 and convey information back to a user of the device. Examples of such client devices include personal computers, cell phones, handheld messaging devices, laptop computers, set-top boxes, personal data assistants, electronic book readers, and the like. The network can include any appropriate network, including an intranet, the Internet, a cellular network, a local area network, or any other such network or combination thereof. Components used for such a system can depend at least in part upon the type of network and/or environment selected. Protocols and components for communicating via such a network are well known and will not be discussed herein in detail. Communication over the network can be enabled by wired or wireless connections and combinations thereof. In this example, the network includes the Internet, as the environment includes a Web server 706 for receiving requests and serving content in response thereto, although for other networks an alternative device serving a similar purpose could be used as would be apparent to one of ordinary skill in the art.

The illustrative environment includes at least one application server 708 and a data store 710. It should be understood that there can be several application servers, layers, or other elements, processes, or components, which may be chained or otherwise configured, which can interact to perform tasks such as obtaining data from an appropriate data store. As used herein the term “data store” refers to any device or combination of devices capable of storing, accessing, and retrieving data, which may include any combination and number of data servers, databases, data storage devices, and data storage media, in any standard, distributed, or clustered environment. The application server can include any appropriate hardware and software for integrating with the data store as needed to execute aspects of one or more applications for the client device, handling a majority of the data access and business logic for an application. The application server provides access control services in cooperation with the data store and is able to generate content such as text, graphics, audio, and/or video to be transferred to the user, which may be served to the user by the Web server in the form of HyperText Markup Language (“HTML”), Extensible Markup Language (“XML”), or another appropriate structured language in this example. The handling of all requests and responses, as well as the delivery of content between the client device 702 and the application server 708, can be handled by the Web server. It should be understood that the Web and application servers are not required and are merely example components, as structured code discussed herein can be executed on any appropriate device or host machine as discussed elsewhere herein.

The data store 710 can include several separate data tables, databases or other data storage mechanisms and media for storing data relating to a particular aspect. For example, the data store illustrated includes mechanisms for storing production data 712 and user information 716, which can be used to serve content for the production side. The data store also is shown to include a mechanism for storing log data 714, which can be used for reporting, analysis, or other such purposes. It should be understood that there can be many other aspects that may need to be stored in the data store, such as for page image information and to access right information, which can be stored in any of the above listed mechanisms as appropriate or in additional mechanisms in the data store 710. The data store 710 is operable, through logic associated therewith, to receive instructions from the application server 708 and obtain, update or otherwise process data in response thereto. In one example, a user might submit a search request for a certain type of item. In this case, the data store might access the user information to verify the identity of the user and can access the catalog detail information to obtain information about items of that type. The information then can be returned to the user, such as in a results listing on a Web page that the user is able to view via a browser on the user device 702. Information for a particular item of interest can be viewed in a dedicated page or window of the browser.

Each server typically will include an operating system that provides executable program instructions for the general administration and operation of that server and typically will include a computer-readable storage medium (e.g., a hard disk, random access memory, read only memory, etc.) storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 7. Thus, the depiction of the example environment 700 in FIG. 7 should be taken as being illustrative in nature and not limiting to the scope of the disclosure.

The various embodiments further can be implemented in a wide variety of operating environments, which in some cases can include one or more user computers, computing devices or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

Most embodiments utilize at least one network that would be familiar to those skilled in the art for supporting communications using any of a variety of commercially-available protocols, such as Transmission Control Protocol/Internet Protocol (“TCP/IP”), Open System Interconnection (“OSI”), File Transfer Protocol (“FTP”), Universal Plug and Play (“UpnP”), Network File System (“NFS”), Common Internet File System (“CIFS”), and AppleTalk. The network can be, for example, a local area network, a wide-area network, a virtual private network, the Internet, an intranet, an extranet, a public switched telephone network, an infrared network, a wireless network, and any combination thereof.

In embodiments utilizing a Web server, the Web server can run any of a variety of server or mid-tier applications, including Hypertext Transfer Protocol (“HTTP”) servers, FTP servers, Common Gateway Interface (“CGP”) servers, data servers, Java servers, and business application servers. The server(s) also may be capable of executing programs or scripts in response to requests from user devices, such as by executing one or more Web applications that may be implemented as one or more scripts or programs written in any programming language, such as Java®, C, C#, or C++, or any scripting language, such as Perl, Python, or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (“CPU”), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired)), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, Electrically Erasable Programmable Read-Only Memory (“EEPROM”), flash memory or other memory technology, Compact Disc Read-Only Memory (“CD-ROM”), digital versatile disk (DVD), or other optical storage, magnetic cassettes, magnetic tape, magnetic disk storage, or other magnetic storage devices, or any other medium which can be used to store the desired information and which can be accessed by a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions, and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A system, comprising:
a microphone input device;
a memory configured to store computer-executable instructions; and
a processor configured to access the memory and execute the computer-executable instructions to at least:
receive first voice input data via the microphone input device;
generate a first search query for searching an item database, the first search query comprising search terms derived from the first voice input data;
generate first search results responsive to the first search query;
receive second voice input data via the microphone input device;
generate a second search query for searching the item database, the second search query comprising second search terms derived from the second voice input data;
determine, using a machine learning algorithm having inputs of the first search query and the second search query, a score indicative of a probability that the second search query is a refinement of the first search query; and
generate, in response to the score exceeding a threshold, second search results based on the first search query and the second search query.

2. The system of claim 1, wherein the computer-executable instructions further cause the processor to:
prior to receiving the second voice input data, receive contextual information related to one or more user with respect to the item database, and wherein determining the score further comprises using the machine learning algorithm having the contextual information as an additional input.

3. The system of claim 2, wherein the contextual information comprises at least one of:
historical search queries for searching the item database;
screen context of a view of the item database displaying the first search results; or
a time of the first voice input data and a time of the second voice input data.

4. The system of claim 1, wherein the machine learning algorithm comprises a Bidirectional Encoder Representations from Transformers (BERT) algorithm.

5. A computer-implemented method, comprising:
receiving first input data associated with a first search query;
generating first search results responsive to the first search query;
receiving second input data associated with a voice request;
generating a second search query by processing the voice request with a natural language processing algorithm;
determining, using a machine learning algorithm having inputs of the first search query and the second search query, a score indicative of a probability that the second search query is a refinement of the first search query; and
generating, in response to the score exceeding a threshold, second search results based on the first search query and the second search query.

6. The computer-implemented method of claim 5, wherein generating the second search results comprises filtering a subset of the first search results based on the second search query.

7. The computer-implemented method of claim 5, wherein generating the second search results comprises performing a new search using both the first search query and the second search query.

8. The computer-implemented method of claim 5, wherein the first input data is at least one of:
a voice input; or
a typed input.

9. The computer-implemented method of claim 5, further comprising:
prior to receiving the second voice input data, receive contextual information related to one or more user actions with respect to the item database, and wherein determining the score further comprises using the machine learning algorithm having the contextual information as an additional input.

10. The computer-implemented method of claim 9, wherein the contextual information comprises:
historical search queries for searching the item database;
screen context of a view of the item database displaying the first search results;
browsing history of the user device; or
a time of the first input data and a time of the second input data.

11. The computer-implemented method of claim 5, wherein:
the first search query comprises an item class; and
generating the second search results comprises determining that the second search query comprises an item property of a subset of the item class.

12. The computer-implemented method of claim 5, wherein the first input data comprises an initial voice request, the method further comprising:
identifying, by processing the initial voice request with the natural language processing algorithm, an item identifier associated with an item class; and
determining that a search term of the second search query is associated with a filter category related to the item class, and wherein determining the score comprises having the item class and the filter category as inputs of the machine learning algorithm.

13. The computer-implemented method of claim 5, wherein the first search query comprises first search terms derived from the first input data, and the second search query comprises second search terms derived from the second input data.

14. The computer-implemented method of claim 5, further comprising:
receiving third input data associated with an additional voice request;
generating a third search query by processing the additional voice request with the natural language processing algorithm;
determining, using a machine learning algorithm having inputs of the first search query, the second search query, and the third search query, a second score indicative of a second probability that the third search query is a refinement of the first search query and the second search query; and
generating, in response to the second score exceeding the threshold, third search results based on the first search query, the second search query, and the third search query.

15. A system, comprising:
a memory configured to store computer-executable instructions; and
a processor configured to access the memory and execute the computer-executable instructions to at least:
receive first input data associated with a first search query;
generate first search results responsive to the first search query;
receive second input data associated with a voice request;
generate a second search query by processing the voice request with a natural language processing algorithm;
determine, using a machine learning algorithm having inputs of the first search query and the second search query, a score indicative of a probability that the second search query is a refinement of the first search query; and
generate, in response to the score exceeding a threshold, second search results based on the second search query.

16. The system of claim 15, wherein the computer-executable instructions to generate the second search results comprise further instructions that, when executed, cause the processor to filter a subset of the first search results base on the second search query.

17. The system of claim 15, wherein the computer-executable instructions to generate the second search results comprise further instructions that, when executed, cause the processor to perform a new search using both the first search query and the second search query.

18. The system of claim 15, wherein the computer-executable instructions to generate the second search results to refine the first search results to only include items related to both the first search query and the second search query.

19. The system of claim 15, wherein the computer-executable instructions to generate the second search results comprises further instructions that, when executed, cause the processor to:
determine a subset of the first search results associated with the second search query; and
present the subset of the first search results as the second search results.

20. The system of claim 15, wherein the machine learning algorithm comprises a transformer-based machine learning algorithm.
